(19) United States
(12) Patent Application Publication
(10) Pub. No.: US 2012/0013708 A1
(43) Pub. Date: Jan. 19, 2012

(54) CONTROL APPARATUS, STEREOSCOPIC IMAGE CAPTURING APPARATUS, AND CONTROL METHOD

(75) Inventor: Ryoichi OKUBO, Tokyo-to (JP)

(73) Assignee: VICTOR COMPANY OF JAPAN, LIMITED, Yokohama-shi (JP)

(21) Appl. No.: 13/180,927

(22) Filed: Jul. 12, 2011

(30) Foreign Application Priority Data
Jul. 14, 2010 (JP) 2010-159764

(51) Int. Cl. H04N 13/00

(52) U.S. Cl. 348/43; 348/E13.074

(57) ABSTRACT

Finger coverage in an image for making a viewer sense a stereoscopic image is quickly detected with low load. A central controller includes a difference determiner which determines existence of a difference based on a predetermined determination standard by comparing left eye image data and right eye image data for making a viewer to sense a stereoscopic image based on the predetermined determination standard, and an execution controller which, when it is determined by the difference determiner that there is a difference, enables a controlled unit to execute a process different from when it is determined that there is no difference.

### CROSS-REFERENCE TO RELATED PATENT APPLICATIONS

This application claims the benefit of Japanese Patent Application No. 2010-159764 filed on Jul. 14, 2010, in the Japan Patent Office, the disclosure of which is incorporated herein in its entirety by reference.

### BACKGROUND OF THE INVENTION

1. Field of the Invention

The present invention relates to a control apparatus and a control method that compare images for making a viewer sense a stereoscopic image, and a stereoscopic image capturing apparatus that generates an image for making a viewer sense a stereoscopic image.

2. Description of the Related Art

Recently, a photographing apparatus, such as a digital video camera, a digital camera, or the like, is being miniaturized. However, as the photographing apparatus is miniaturized, a phenomenon where a finger of a photographer partially covers a lens, that is, so-called finger coverage, may be easily generated while the photographer firmly holds the photographing apparatus. Thus, a technology of notifying about finger coverage by determining whether a finger of a photographer is included within an area to be photographed, based on a plurality of pieces of image data continuously obtained in time series, is disclosed (For example, Patent Reference 1: Japanese Laid-Open Patent Publication No. 2004-40712).

Here, a technology of making a viewer sense a stereoscopic image by using two images that generate binocular parallax is being propagated. In this technology, a left eye image is perceived by a left eye of a viewer and a right eye image is perceived by a right eye of the viewer so that the viewer senses a stereoscopic image (3D image). A stereoscopic image capturing apparatus that generates left eye image data and right eye image data for making a viewer sense a stereoscopic image mainly includes two lenses (image pickup units) so as to respectively generate left eye image data and right eye image data.

According to a technology of Patent Reference 1, image data accumulated for a predetermined time or image data having an interval of a predetermined time therebetween from among a plurality of pieces of image data obtained in time series need to be compared at the time of detecting finger coverage, such that a change in relative positions of a subject to be photographed and a portion where a finger or the like is photographed are clarified. Accordingly, when an image is captured by using the technology of Patent Reference 1, time is required to some extent for finger coverage to be detected after the finger coverage is generated, and the photographing apparatus undesirably and continuously stores image data containing a finger until a photographer is notified about the finger coverage and removes the finger. Also, in the technology of Patent Reference 1, when finger coverage is detected, a massive amount of past image data is used, and thus in order to temporarily hold the past image data, an image buffer having a relatively large storage capacity is required.

For example, when the technology of Patent Reference 1 is applied to capturing a left eye image and a right eye image for making a viewer sense a stereoscopic image, image data obtained in time series with respect to each of a left eye image and a right eye image are compared. Here, image data in which a finger is undesirably photographed as described above is stored for a long time or storage capacity of an image buffer is simply doubled, and thus process load consumed to detect finger coverage is doubled.

### SUMMARY OF THE INVENTION

To solve the above and/or other problems, the present invention provides a control apparatus, a stereoscopic image capturing apparatus, and a control method that are capable of detecting finger coverage quickly and with low load.

According to an aspect of the present invention, there is provided a control apparatus including: a difference determiner which determines existence of a difference based on a predetermined determination standard by comparing left eye image data and right eye image data for making a viewer sense a stereoscopic image based on the predetermined determination standard; and an execution controller which, when it is determined by the difference determiner that there is a difference, enables a controlled unit to execute a process different from when it is determined that there is no difference.

The predetermined determination standard may be quantity of light.

The predetermined determination standard may be resolution.

The predetermined determination standard may be a shape of a subject.

The difference determiner may compare the left eye image data and the right eye image data by using data corresponding to an area excluding at least a center portion of an image based on the left eye image data, and data corresponding to an area excluding at least a center portion of an image based on the right eye image data.

The controlled unit may be a notifying unit which notifies about information, and when it is determined by the difference determiner that there is a difference, the execution controller may enable the notifying unit to notify the result of the determination that there is the difference.

The controlled unit may be an image storage unit which stores the left eye image data and right eye image data, and the execution controller may store the left eye image data and the right eye image data in the image storage unit only when the difference determiner determines that there is no difference.

The controlled unit may be an image substitutor which substitutes partial image data of one of the left eye image data and the right eye image data with partial image data of the other of the left eye image data and the right eye image data, and when the difference determiner determines that there is a difference, the execution controller may enable the image substitutor to substitute the partial image data of one of the left eye image data and the right eye image data with the partial image data of the other of the left eye image data and the right eye image data, so as to reduce a difference in a portion having the difference.

The controlled unit may be an image cut-out unit which cuts out a part of each of the left eye image data and the right eye image data, and when the difference determiner determines that there is a difference, the execution controller may enable the image cut-out unit to cut out the part of each of the left eye image data and the right eye image data so as to exclude a portion having the difference.

According to another aspect of the present invention, there is provided a stereoscopic image capturing apparatus, the apparatus including: the control apparatus; and an image pickup unit which generates the left eye image data and the right eye image data.

According to another aspect of the present invention, there is provided a control method including: determining existence of a difference based on a predetermined determination standard by comparing left eye image data and right eye image data for making a viewer sense a stereoscopic image based on the predetermined determination standard; and when there is the difference, executing a process that is different from a process executed when there is no difference.

Elements or descriptions thereof based on a technical aspect of the stereoscopic image capturing apparatus described above are applicable to the control method.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are views for explaining a stereoscopic image capturing apparatus;

FIG. 2 is a functional block diagram showing a schematic structure of the stereoscopic image capturing apparatus;

FIGS. 3A and 3B are views for explaining predetermined regions to be compared by a difference determiner of the stereoscopic image capturing apparatus;

FIG. 4 is views for explaining a detailed comparison process of the difference determiner of the stereoscopic image capturing apparatus;

FIGS. 5A and 5B are views for explaining comparison of shapes of subjects by the difference determiner of the stereoscopic image capturing apparatus;

FIGS. 6A and 6B are views for explaining processes when a display unit is used as a notifying unit;

FIGS. 7A through 7C are views for explaining a substituting process of an image processor of the stereoscopic image capturing apparatus;

FIGS. 8A through 8C are views for explaining a cut-out process of the image processor of the stereoscopic image capturing apparatus; and

FIG. 9 is a flowchart showing a flow of processes of a control method.

### DETAILED DESCRIPTION OF EMBODIMENTS

Hereinafter, the present invention will be described in detail by explaining exemplary embodiments of the invention with reference to the attached drawings. Measurements, materials, other detailed numerical values, etc. in the embodiments are only examples for easy understanding of the invention, and do not limit the present invention unless specifically specified. In the specification and drawings, like reference numerals are used for elements having substantially the same functions and structures to omit overlapping descriptions, and any element that is not directly related to the present invention is omitted.

A control apparatus, for example, is a central controller of a stereoscopic image capturing apparatus that generates or edits an image for making a viewer sense a stereoscopic image, a personal computer, a stereoscopic image reproducing apparatus that reproduces an image for making a viewer sense a stereoscopic image, an apparatus capable of adding functions to the stereoscopic image capturing apparatus, the personal computer, and the stereoscopic image reproducing apparatus, or the like. In the following descriptions, an exemplary embodiment in which the control apparatus is the central controller of the stereoscopic image capturing apparatus will be explained. Specifically, a structure of the stereoscopic image capturing apparatus will be described first, and then a central controller will be described.

Also, in the following descriptions, a difference between locations of a photographed object or a difference between orientations of the photographed object in two images captured by two image pickup units of the stereoscopic image capturing apparatus will also be referred to as parallax. Further, finger coverage also includes a state in which an object other than a finger covers an imaging lens. However, in the following descriptions, an example of detecting a state in which a finger covers an imaging lens will be described.

Stereoscopic Image Capturing Apparatus 100

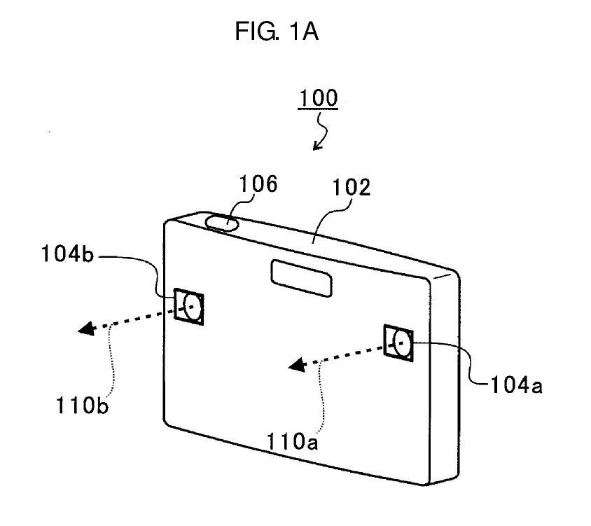

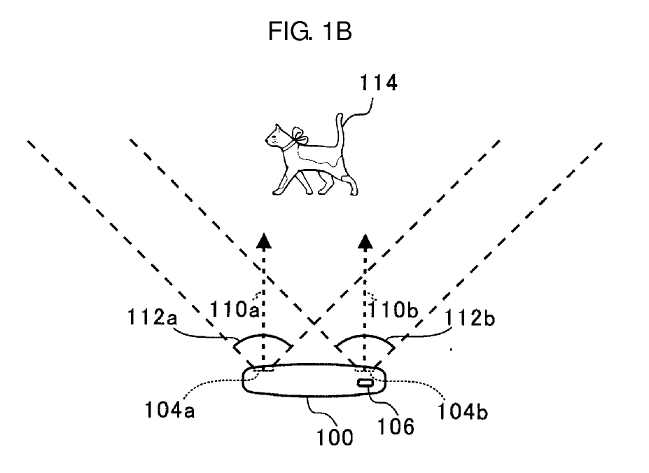

FIGS. 1A and 1B are views for explaining the stereoscopic image capturing apparatus 100 including a control apparatus (central controller 138), according to an embodiment of the present invention. Specifically, FIG. 1A shows an exterior of the stereoscopic image capturing apparatus 100, and FIG. 1B shows a relationship between viewing angles 112a and 112b of the stereoscopic image capturing apparatus 100 and a subject 114. In the present embodiment, a so-called digital still camera is used as the stereoscopic image capturing apparatus 100. The stereoscopic image capturing apparatus 100 includes a body 102, two imaging lenses 104a and 104b, and a manipulator 106. In the present embodiment, a digital still camera including a function of capturing an image is used as an example of the stereoscopic image capturing apparatus 100, but the stereoscopic image capturing apparatus 100 is not limited thereto and may be another electronic device having a function of capturing an image, such as a digital video camera, a mobile phone, a personal handy-phone system (PHS), a portable video game system, or the like.

Also, the stereoscopic image capturing apparatus 100 may be an image capturing apparatus that stores a moving image or a still image. Also, image data may be still image data or moving image data. Also, in the following descriptions, the stereoscopic image capturing apparatus 100 includes the control apparatus, but the control apparatus may be separated from the stereoscopic image capturing apparatus 100. In this case, the control apparatus obtains left eye image data and right eye image data generated by the stereoscopic image capturing apparatus 100, and compares the left eye image data and the right eye image data based on a predetermined determination standard, thereby determining existence of a difference based on the predetermined determination standard.

As shown in FIG. 1A, an image pickup unit of the stereoscopic image capturing apparatus 100 is provided in such a way that, when a photographer firmly holds the body 102 of the stereoscopic image capturing apparatus 100 horizontally, imaging axes 110a and 110b are formed in an approximately parallel direction to each other or crossed in imaging directions on the same horizontal surface. Here, as shown in FIGS. 1A and 1B, the imaging axes 110a and 110b indicate the imaging directions, and are lines extending from a center point (image center point) of an image generated by the image pickup unit to the imaging directions. In the present embodiment, the imaging axes 110a and 110b are approximately parallel to each other.

The stereoscopic image capturing apparatus 100 photographs the subject 114 included in range of each of the viewing angles 112a and 112b of two image pickup units, and generates two pieces of image data (left eye image data and right eye image data) that make a viewer sense a stereoscopic image by using parallax of the two pieces of image data.

The stereoscopic image capturing apparatus 100 stores the two pieces of image data for making a viewer sense a stereoscopic image, which are generated via the two imaging lenses 104a and 104b and generate binocular parallax for a viewer, according to a predetermined method for making a viewer sense a stereoscopic image, such as a side-by-side method, a top-and-bottom method, a line sequential method, a frame sequential method, or the like. The stereoscopic image capturing apparatus 100 also adjusts an imaging timing or a viewing angle of the two pieces of image data according to a manipulation input of the photographer through the manipulator 106.

However, since the stereoscopic image capturing apparatus 100 is miniaturized so as to increase portability, so-called finger coverage, wherein a finger of the photographer covers a part of the imaging lens 104a or 104b, while the photographer firmly holds the stereoscopic image capturing apparatus 100, may be generated. Specifically, as shown in FIG. 1A, in the stereoscopic image capturing apparatus 100 for capturing a stereoscopic image, it is effective to space the imaging axis 110a and the imaging axis 110b apart from each other by a distance between eyes of a person (inter-eye distance), and since a lens is disposed relatively at an end portion of the stereoscopic image capturing apparatus 100, finger coverage may be more easily generated. Accordingly, the stereoscopic image capturing apparatus 100 according to the present embodiment quickly detects finger coverage with low load by comparing the left eye image data and the right eye image data. Hereinafter, the stereoscopic image capturing apparatus 100 will be described.

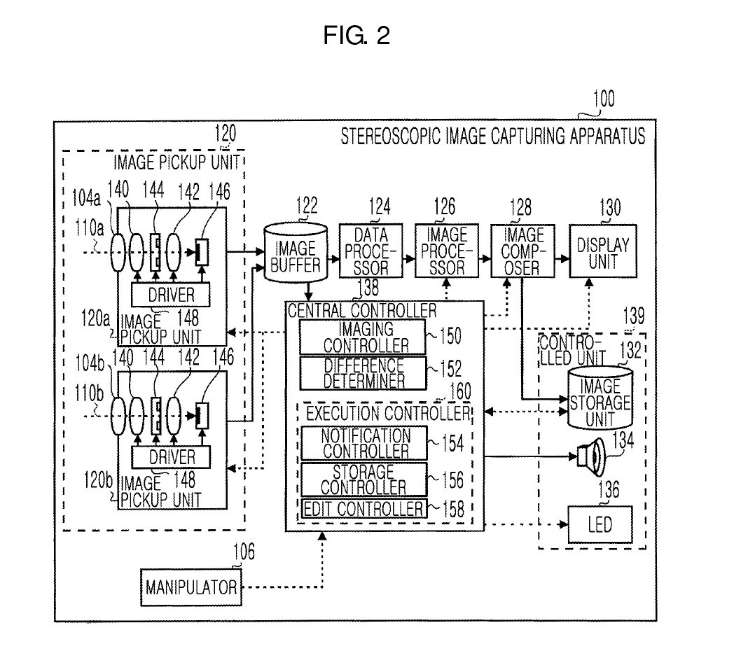

FIG. 2 is a functional block diagram showing a schematic structure of the stereoscopic image capturing apparatus 100. As shown in FIG. 2, the stereoscopic image capturing apparatus 100 includes the manipulator 106, an image pickup unit 120 having two image pickup units 120a and 120b, an image buffer 122, a data processor 124, an image processor 126, an image composer 128, a display unit 130, an image storage unit 132, a speaker 134, a light emitting diode (LED) 136, and the central controller (control apparatus) 138. The display unit 130, the image storage unit 132, and the speaker 134 are an example of a controlled unit 139. In FIG. 2, a solid arrow line denotes a flow of data and a broken arrow line denotes a flow of a control signal.

The manipulator 106 includes a switch, such as a manipulation key including a release switch, a cross key, a joy stick, a touch panel overlapped on a display surface of the display unit 130, or the like, thereby receiving a manipulation input of the photographer.

As described above, the image pickup unit 120 is disposed such that each of the imaging axes 110a and 110b are approximately parallel to each other or crosses at a predetermined convergence point imaging directions. Also, when image data generating (recording) is selected according to a manipulation input of the photographer via the manipulator 106, the image pickup units 120a and 120b respectively generate the left eye image data and the right eye image data, and output the image data (left eye image data and right eye image data) to the image buffer 122.

In detail, the image pickup unit 120 includes the imaging lens (shown as 104a and 104b in FIG. 2), a zoom lens 140 used to change a viewing angle, a focus lens 142 used to adjust a focus, an iris 144 used to adjust light exposure, an imaging device 146 for photoelectrically-converting luminous flux received through the imaging lens 104a or 104b into image data, and a driver 148 for driving each of the zoom lens 140, the focus lens 142, the iris 144, and the imaging device 146 according to a control signal of an imaging controller 150, which will be described later. The image pickup unit 120 generates the two pieces of image data (left eye image data and right eye image data) with respect to the two imaging axes 110a and 110b. According to the present embodiment, the two image pickup units 120a and 120b are interlocked with each other, and thus drive the zoom lens 140, the focus lens 142, the iris 144, and the imaging device 146 in synchronization with each other, according to the control signal of the imaging controller 150.

The image buffer 122 may be RAM (Random Access Memory), or the like, and temporarily holds the left eye image data generated by the image pickup unit 120a and the right eye image data generated by the image pickup unit 120b in units of frames. Here, the frames denote still images obtained in time series that form an image.

The data processor 124 executes an image signal process, such as an R (Red) G (Green) B (Blue) process (y correction or color correction), an image enhancement process, a noise reduction process, or the like, on the left eye image data and the right eye image data outputted from the image buffer 122.

The image processor 126 executes a substituting process or a cut-out process on partial image data that are parts of the left eye image data and right eye image data, according to a control command of an edit controller 158. Processes of the edit controller 158 will be described later.

The image composer 128 composes (merges) the left eye image data and the right eye image data outputted from the image processor 126, and outputs composed left and right eye image data to the display unit 130 or the image storage unit 132. In detail, the image composer 128 generates composite data corresponding to a predetermined method for making a viewer sense a stereoscopic image, for example, a line sequential method, wherein left eye image data and right eye image data are disposed every other line (1 line interval) to be perceived via polarizing glasses, a frame sequential method, wherein a left eye image and a right eye image are alternately displayed in units of frames to be perceived via electronic shutter glasses, or a method, wherein a proceeding direction of light of each of a left eye image and a right eye image is controlled by using a lenticular lens, and outputs the composite data to the display unit 130 or the image storage unit 132.

Alternatively, for example, when the display unit 130 in which different polarizations are observed in every line based on a polarization display method or the like, is used, the image composer 128 outputs the composite data according to the line sequential method, the frame sequential method, the method using the lenticular lens, or the like, and the photographer perceives a left eye image only with a left eye and a right eye image only with a right eye by being equipped with polarizing glasses or the like, thereby sensing an image based on the composite data as a stereoscopic image.

The display unit 130 may be a liquid crystal display, an organic EL (Electro Luminescence) display, or the like, and displays the images based on the composite data outputted by the image composer 128. Here, the stereoscopic image capturing apparatus 100 includes the display unit 130, but the present invention is not limited thereto. The stereoscopic image capturing apparatus 100 may use an external display device. Also, the display unit 130 may display the left eye image data and the right eye image data without composing them.

The photographer manipulates the manipulator 106 while perceiving the images displayed on the display unit 130, and thus can photograph the subject at a desired location and range.

The image storage unit 132 stores the composite data outputted from the image composer 128 according to a control signal of a storage controller 156, which will be described later. An HDD (Hard Disk Drive), flash memory, nonvolatile RAM, or the like may be used as the image storage unit 132. Alternatively, the image storage unit 132 may be configured as an apparatus for storing the composite data in a detachable storage medium, for example, an optical disk medium, such as a CD (Compact Disc), a DVD (Digital Versatile Disk), or a BD (Blu-ray Disc), a portable memory card, or the like. Here, the image storage unit 132 may encode the image data according to a predetermined encoding method, such as M-JPEG (Motion JPEG), MPEG (Moving Picture Experts Group)-2, H.264, or the like.

The speaker 134 outputs an alarm when, for example, finger coverage is generated, according to a control command of a notification controller 154. The LED 136 is lighted when, for example, finger coverage is generated, according to a control command of the notification controller 154.

The central controller 138 manages and controls the entire stereoscopic image capturing apparatus 100, according to a semiconductor integrated circuit including a central processing unit (CPU), ROM storing a program or the like, RAM as a work area, etc. Also, according to the present embodiment, the central controller 138 operates as the imaging controller 150, a difference determiner 152, the notification controller 154, the storage controller 156, and the edit controller 158. The notification controller 154, the storage controller 156, and the edit controller 158 are an example of an execution controller 160.

The image controller 150 controls the image pickup unit 120 according to a manipulation input of the photographer, i.e., information supplied from the manipulator 106. For example, the imaging controller 150 enables the driver 148 to drive the zoom lens 140, the focus lens 142, the iris 144, and the imaging device 146 so as to obtain suitable image data.

The difference determiner 152 determines existence of a difference based on a predetermined determination standard, by comparing the left eye image data and the right eye image data based on the predetermined determination standard. According to the present embodiment, a difference between the left eye image data and the right eye image data determined to exist by the difference determiner 152 does not include misalignment due to misalignment of optical axes of the image pickup units 120a and 120b, i.e., parallax misalignment. Here, the difference determiner 152 may compare the left eye image data and the right eye image data by using data corresponding to an area excluding at least a center portion of the image based on the left eye image data, and data corresponding to an area excluding at least a center portion of the image based on the right eye image data.

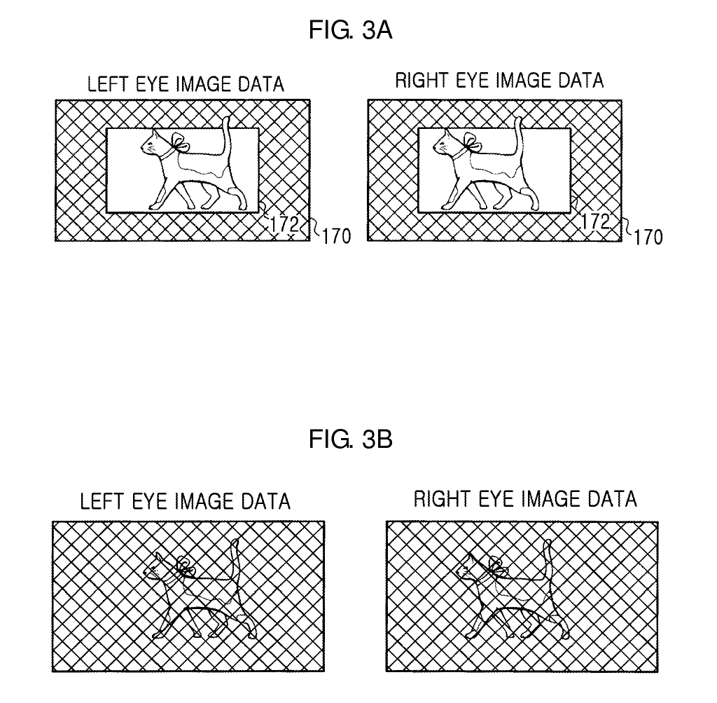

FIGS. 3A and 3B are views for explaining predetermined regions 170 to be compared by the difference determiner 152, and show the image based on the left eye image data and the image based on the right eye image data. Specifically, FIG. 3A shows an example where the predetermined region 170 (indicated by cross hatching in FIG. 3A) excluding a center portion 172 (indicated by a white rectangle in FIG. 3A) is used as an object to be compared, and FIG. 3B shows an example where an entire image is used as an object to be compared. Since a finger is stretched from a hand that firmly holds the stereoscopic image capturing apparatus 100, when finger coverage is generated, the finger inevitably covers somewhere in a perimeter boundary of the imaging lens 104a or 104b. Thus, while detecting finger coverage, the difference determiner 152 may compare partial image data corresponding to at least the perimeter boundary.

Accordingly, as shown in FIG. 3A, the difference determiner 152 narrows down an object to be compared to data corresponding to the predetermined region 170 excluding the center portion 172, thereby reducing process load compared to a case when objects to be compared in the image based on the left eye image data and the image based on the right eye image data shown in FIG. 3B are not narrowed down. Also, by narrowing down a range of the object to be compared to the data corresponding to the predetermined region 170 excluding the center portion 172, a detection error due to a reason other than finger coverage may be prevented.

Also, the difference determiner 152 compares the left eye image data and the right eye image data by using, for example, quantity of light as a determination standard (the predetermined determination standard).

When finger coverage is generated, an image of a portion where a finger 174 or the like is photographed is dark since light transmitted to the imaging lens 104a or 104b is blocked by the finger 174 or the like. Accordingly, when the finger 174 or the like is photographed in any one of the left eye image data and the right eye image data, quantities of light in the left eye image data and right eye image data are different from each other.

Alternatively, the fingers 174 or the like may be photographed in both the left eye image data and the right eye image data. However, since the imaging lenses 104a and 104b are spaced apart from each other by an inter-eye distance in left and right directions, the finger 174 or the like does not cover the same portions of the imaging lenses 104a and 104b unless intended. Accordingly, quantities of light in a portion where the finger 174 or the like is photographed in the left eye image data and in a portion where the finger 174 or the like is photographed in the right eye image data are different. Also, even if finger coverage is generated in each of the imaging lenses 104a and 104b, it is highly likely that ranges of the finger 174 covering the imaging lenses 104a and 104b are different in the left eye image data and the right eye image data, and thus the quantities of light in data in both the images also are different. Accordingly, the difference determiner 152 may detect existence of finger coverage by using quantity of light as a determination standard.

The difference determiner 152 determines that there is finger coverage, when a difference between entire quantity of light (sum or average value of luminance values) in 1 frame of the left eye image data and entire quantity of light in 1 frame of the right eye image data exceeds a first predetermined value. Specifically, the difference determiner 152 determines that the finger 174 or the like is being photographed in one of the left eye image data and the right eye image data where the quantity of light is lower than the other. Accordingly, it is possible for the difference determiner 152 to detect finger coverage with a simple process.

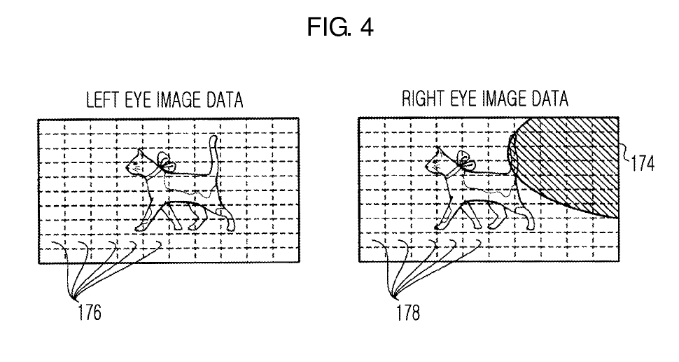

Alternatively, the difference determiner 152 may perform a more detailed comparison process by dividing a screen into a plurality of blocks and determining quantity of light in each of the blocks. FIG. 4 is views for explaining a detailed comparison process of the difference determiner 152. Here, the finger 174 is photographed in the right eye image data (shown as hatching in FIG. 4). As shown in FIG. 4, the difference determiner 152 divides each of the left eye image data and the right eye image data into blocks 176 and 178 having a predetermined size, respectively, and detects quantity of light (sum or average value of luminance values in the present embodiment) per pixel in each of the blocks 176 and 178, thereby deriving a difference between luminance values in each block 178 of the right eye image data and each corresponding block 176 of the left eye image data. Also, when a number of blocks (i.e., blocks where the finger 174 is photographed) where the difference of luminance values exceeds a first predetermined value, exceeds a first predetermined number, it is determined that finger coverage is generated. Specifically, the difference determiner 152 determines that the finger 174 or the like is photographed in a block having lower quantity of light, from among the blocks 176 and 178 in which the difference of luminance values exceeds the first predetermined value. The first predetermined value or the first predetermined number may be arbitrarily set according to an imaging environment, such as according to a block size or the like.

According to such a structure of comparing the blocks 176 and 178 by using quantity of light as a determination standard, the difference determiner 152 can definitely and easily detect finger coverage based on a difference in locations of portions where the finger coverage is generated, even if the portions where the finger coverage is generated happen to have approximately the same area in the left eye image data and the right eye image data.

Alternatively, the difference determiner 152 may compare the left eye image data and the right eye image data by using, for example, resolution as a determination standard (the predetermined determination standard). In other words, the predetermined determination standard may be resolution. According to the present embodiment, resolution is an index indicating clarity of a boundary where color or brightness changes, such as an outline or the like of the subject in an image. Resolution, for example, is indicated in a value of sharpness or the like.

When finger coverage is generated, an image having a portion where the finger 174 or the like is photographed is out of focus and has low resolution, e.g., low sharpness. As described above, since the imaging lenses 104a and 104b are spaced apart from each other by the distance between eyes in the left and right directions, the finger 174 or the like does not simultaneously cover the same portions of the imaging lenses 104a and 104b unless intended. Accordingly, resolutions of a portion where the finger 174 or the like is photographed in the left eye image data and a portion where the finger 174 or the like is photographed in the right eye image data are different.

Accordingly, the difference determiner 152 determines existence of a difference by comparing the left eye image data and the right eye image data by using resolution as a determination standard.

The difference determiner 152 determines that finger coverage is generated when a difference between entire resolution of 1 frame of the left eye image data and entire resolution of 1 frame of the right eye image data exceeds a second predetermined value. Specifically, the difference determiner 152 determines that the finger 174 or the like is photographed when the resolution of one from among the left eye image data and the right eye image data is lower than that of the other. Accordingly, the difference determiner 152 can detect finger coverage with a simple process regardless of quantity of light.

Also, while using resolution as a determination standard, like using quantity of light as a determination standard, each of the left eye image data and the right eye image data may be divided into the blocks 176 and 178 having a predetermined size as shown in FIG. 4, and resolution of each of the blocks 176 and 178 may be derived, thereby determining generation of finger coverage if a number of blocks (i.e., blocks where the finger 174 is photographed in FIG. 4) in which a difference of resolutions between blocks 176 and 178 corresponding to each other exceeds a second predetermined value, exceeds the second predetermined number. Specifically, the difference determiner 152 determines that the finger 174 or the like is photographed in a block with low resolution from among the blocks 176 and 178 in which the difference of resolutions exceeds the second predetermined value. Here, the second predetermined number and the first predetermined number are the same, but alternatively may be different.

According to such a structure of performing comparison in units of blocks 176 and 178 by using resolution as a determination standard, even if, for example, portions where the finger coverage is generated in the left eye image data and the right eye image data happen to have the approximately same area or the same entire resolution, the difference determiner 152 can definitely and easily detect finger coverage based on a difference between the locations of portions where the finger coverage is generated.

Alternatively, the difference determiner 152 may compare the left eye image data and the right eye image data by using, for example, shapes of subjects as a determination standard (the predetermined determination standard).

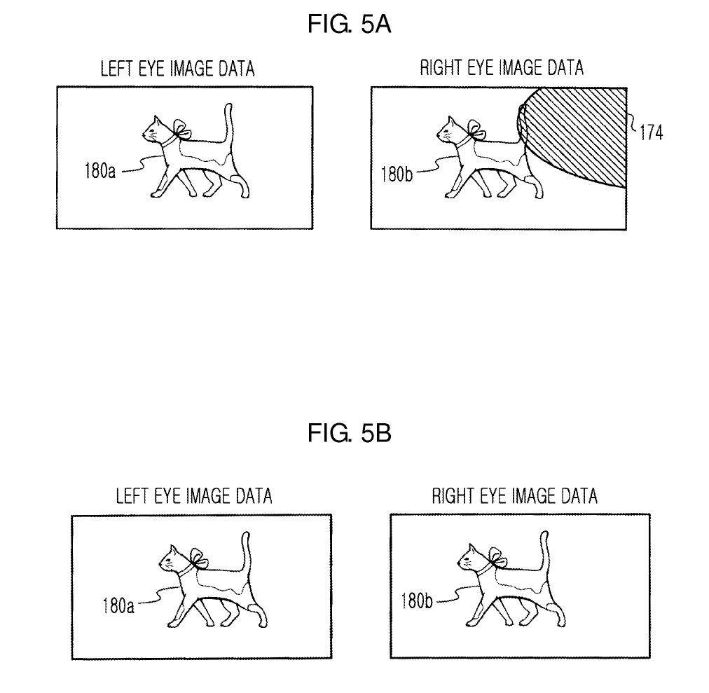

FIGS. 5A and 5B are views for explaining comparison of shapes of subjects 180a and 180b by the difference determiner 152. Specifically, FIG. 5A shows an example when finger coverage is generated and FIG. 5B shows an example when finger coverage is not generated.

When finger coverage is not generated as shown in FIG. 5B, the subjects 180a and 180b are mutually misaligned by parallax, but the shapes of the subjects 180a and 180b are not largely changed between the left eye image data and the right eye image data.

Meanwhile, as shown in FIG. 5A, when finger coverage is generated, the finger 174, not included in the left eye image data, is photographed in the right eye image data. The photographed finger 174 is first recognized as a subject along with other subjects, and the difference determiner 152 compares shapes of all subjects in the left eye image data with shapes of all subjects in the right eye image data.

In detail, the difference determiner 152 specifies subjects mutually misaligned by the parallax in each of the left eye image data and the right eye image data via a process, for example, a block matching of the left eye image data and the right eye image data, or the like. Then, shapes, for example, occupied areas or aspect ratios, of the subjects are compared. When a subject is determined to be captured in only one of the left eye image data and the right eye image data based on a result of the comparison process, the difference determiner 152 determines that the subject is the finger 174 or the like which is photographed. By using shapes of subjects as a determination standard as described above, finger coverage can be definitely detected even if quantities of light or resolutions in the left eye image data and the right eye image data are identical coincidentally.

As such, the difference determiner 152 may clearly detect finger coverage since the difference determiner 152 compares the left eye image data and the right eye image data based on a determination standard that is hardly affected by the parallax between the image based on the left eye image data and the image based on the right eye image data, such as, based on quantities of light, resolutions, shapes of subjects, or the like.

Alternatively, the difference determiner 152 may determine generation of finger coverage by comparing the left eye image data and the right eye image data with respect to each of the determination standards, namely, quantities of light, resolutions, and shapes of subjects, and synthetically determining comparison results. Here, the difference determiner 152 determines that finger coverage is generated, if the difference determiner 152 determines that the left eye image data and the right eye image data are different with respect to all of the determination standards, namely, the quantities of light, the resolutions, and the shapes of the subjects, or determines that finger coverage is generated, if the difference determiner 152 determines that the left eye image data and the right eye image data are different with respect to any one or any two of the determination standards, namely, the quantities of light, the resolutions, and the shapes of the subjects. According to such a structure of synthetic determination using the plurality of determination standards, the difference determiner 152 may detect finger coverage with a higher degree of accuracy.

However, the detecting of finger coverage is only an example, and the difference determiner 152 may also detect a shielding, aside from a finger, for example, garbage or dirt adhered to the imaging lens 104a or 104b or a cover covering the imaging lens 104a or 104b, by comparing the left eye image data and the right eye image data and determining a difference, like the detecting of finger coverage.

In the above-described embodiment, the difference determiner 152 compares 1 recent frame of the left eye image data with 1 recent frame of the right eye image data. However, the present invention is not limited thereto, and a past frame may be used as objects to be compared. Here, the difference determiner 152 compares a predetermined frame from among a current frame and a plurality of past frames of the left eye image data with a predetermined frame from among a current frame and a plurality of past frames of the right eye image data, which are held in the image buffer 122, and determines that finger coverage is generated if there is a difference between the compared predetermined frames. By using the plurality of past frames as objects to be compared, the difference determiner 152 may detect finger coverage with a higher degree of accuracy. However, the left eye image data and the right eye image data compared by the difference determiner 152 may be captured at approximately the same time.

Since the stereoscopic image capturing apparatus 100 according to the present embodiment detects finger coverage by comparing the left eye image data and the right eye image data, finger coverage can be detected even in image data generated, for example, within a short period of time called a frame period of 1 frame, and thus finger coverage can be detected within a short time compared to when pieces of image data having an interval of a predetermined time therebetween are compared. Accordingly, finger coverage may be immediately detected even when photographing is performed immediately after a pan or tilt operation or after power is turned on. Also, finger coverage may be definitely detected without recognizing a subject as a finger even when the subject quickly moves.

Also, in the stereoscopic image capturing apparatus 100 according to the present embodiment, the image buffer 122 for temporarily holding image data for finger coverage detection may have storage capacity to hold only, for example, one frame of each of the left eye image data and the right eye image data, at a time. Thus, manufacturing costs may be reduced. Also, since the stereoscopic image capturing apparatus 100 can simultaneously detect finger coverage in each of the left eye image data and the right eye image data, process load may be reduced compared to when a detecting process is performed individually on two systems of the left eye image data and the right eye image data.

Next, operations of the execution controller 160 (the notification controller 154, the storage controller 156, and the edit controller 158 in the present embodiment) will be described. When the difference determiner 152 determines that there is a difference, the execution controller 160 executes a process different from when there is no difference, with respect to the controlled unit 139 (the display unit 130, the image processor 126, the image storage unit 132, the speaker 134, and the LED 136 in the present embodiment).

When the difference determiner 152 determines that there is a difference, the notification controller 154 notifies about generation of finger coverage to the display unit 130, the LED 132, or the speaker 134 used as a notifying unit.

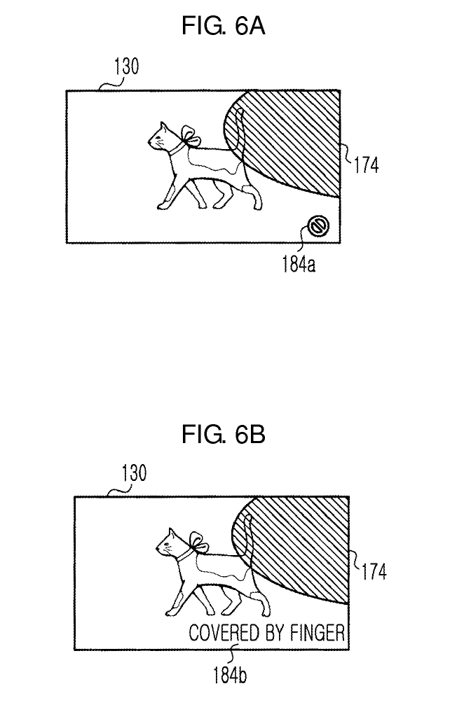

FIGS. 6A and 6B are views for explaining processes when the display unit 130 is used as a notifying unit. Specifically, FIG. 6A shows an example in which an alarm mark 184a is displayed, and FIG. 6B shows an example in which an alarm message 184b is displayed.

When the difference determiner 152 determines that there is a difference, the notification controller 154, for example, outputs an alarm to the speaker 134, displays the alarm mark 184a on the display unit 130 as shown in FIG. 6A, displays the alarm message 184b as shown in FIG. 6B, or lights up the LED 136 or the like, thereby notifying the photographer about finger coverage. Thus, the photographer easily recognizes when finger coverage is generated, and can avoid a state of continuous finger coverage by moving the finger 174 or the like. Also, the notification controller 154 may, for example, display characters on the display unit 130 or output a voice through the speaker 134, about the imaging lens 104a or 104b where finger coverage is generated from among the image lenses 104a and 104b.

The image storage unit 132 stores the composite data generated by the image composer 128 by composing the left eye image data and the right eye image data. Here, the storage controller 156 stores the composite data in the image storage unit 132, only when the difference determiner 152 determines that there is no difference. On the other hand, when it is determined that there is a difference, the storage controller 156 does not store the composite data in the image storage unit 132, but notifies the photographer through, for example, the display unit 130 about the result of the determination that there is a difference.

When there is finger coverage, the generated image data (composite data) is highly likely to be an image that is not desired by the photographer. By limiting the storing of composite data through the storage controller 156, the storage controller 156 stops the image storage unit 132 from deliberately storing unnecessary composite data captured with the finger 174 or the like, thereby effectively using storage capacity of the image storage unit 132. Thus, it is possible to skip troubles of editing and deleting unnecessary composite data later.

Alternatively, when there is finger coverage, the storage controller 156 may store the composite data in the image storage unit 132, and add a flag indicating the generation of the finger coverage to the composite data. In this case, the photographer may easily index and indicate a portion where the finger coverage is generated from the composite data, based on the flag, and thus may delete only a portion which is determined to be unnecessary while perceiving the portion.

When the difference determiner 152 determines that there is a difference, the edit controller 158 may enable the image processor 126 to substitute partial image data of one from among the left eye image data and the right eye image data with partial image data of the other image data so as to reduce a difference in a portion having the difference. Here, the image processor 126 operates as an image substitutor, and substitutes partial image data of one from among the left eye image data and the right eye image data with partial image data of the other image data.

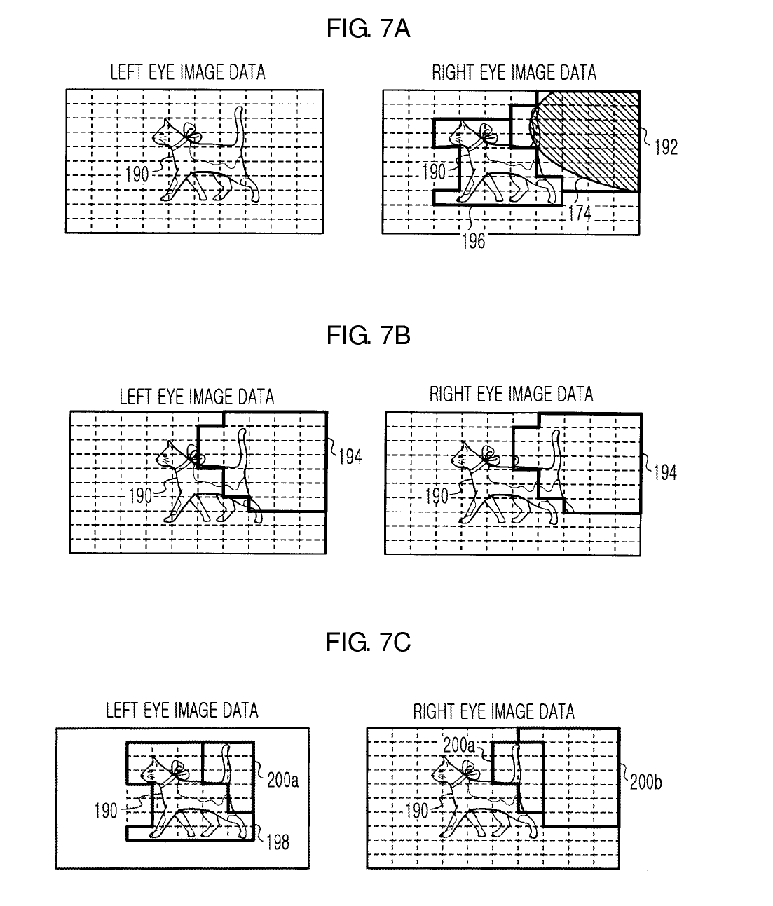

FIGS. 7A and 7B are views for explaining a substituting process of the image processor 126. Specifically, FIG. 7A shows an example of the left eye image data and the right eye image data before the substituting process is performed by the image processor 126, FIG. 7B shows an example of the left eye image data and the right eye image data after the substituting process is performed by the image processor 126, and FIG. 7C shows an example of another substituting process performed by the image processor 126.

The edit controller 158 specifies partial image data 192 of a portion where the finger 174 is photographed (a block determined to have been photographed together with the finger 174 or the like during a comparison process on a block-by-block basis by the difference determiner 152) in one of the left eye image data and the right eye image data determined to have been photographed together with the finger 174 or the like by the difference determiner 152, here, the right eye image data of FIG. 7A. Also, the edit controller 158 enables the image processor 126 to obtain partial image data 194 of the left eye image data of FIG. 7B at the same location as the partial image data 192. Then, as shown in FIG. 7B, the edit controller 158 controls the image processor 126 to substitute the partial image data 192 of the portion where the finger 174 is photographed with the partial image data 194. Accordingly, the image composer 128 may generate composite data as if there is no finger coverage, which has minor misalignment in part of a subject 190 but has almost harmony with a background or the like, by using the right eye image data after substitution and the left eye image data.

However, since the left eye image data and the right eye image data have parallax, even if a block in one image data is simply substituted with a block at the same location in the other image data, a subject may be misaligned in a horizontal direction according to a location where an image is formed. Accordingly, for a more accurate substituting process, the edit controller 158 may substitute partial image data while considering parallax. Here, as shown in FIG. 7A, the edit controller 158 extracts a subject that is predicted to have been covered by the finger 174 in the right eye image data. In detail, the edit controller 158, for example, extracts partial image data 196 including the subject 190 by specifying all subjects including blocks adjacent to a block photographed together with the finger 174, for example, the subject 190.

Then, the edit controller 158 uses the extracted partial image data 196 as a comparison source and the left eye image data as a comparison place, to allow the image processor 126 to extract partial image data 198 of the left eye image data corresponding to the partial image data 196, by using a technology such as block matching or the like. Then, the edit controller 158 specifies the subject 190 included in all blocks of the partial image data 196 as shown in FIG. 7C, and enables the image processor 126 to extract partial image data 200a corresponding to a block of a portion (here, a tail portion of the subject 190) covered by the finger 174 in the right eye image data, wherein the block includes the subject 190 and is connected to the extracted partial image data 198.

The edit controller 158 substitutes a portion of the partial image data 192 of the right eye image data as shown in FIG. 7C by using partial image data 200b constituting a portion that does not overlap with the partial image data 200a, out of the partial image data 194 of the left eye image data described with reference to FIG. 7B. Accordingly, the image composer 128 can generate more natural composite data as if there is no finger coverage, since it is possible to perform a substitution using similar partial image data of a subject.

Alternatively, the edit controller 158 may enable the image processor 126 to substitute the partial image data 192 of the portion photographed with the finger 174 or the like, which is determined by the difference determiner 152 to have a difference among the left eye image data and the right eye image data, with, for example, partial image data of an image having less color change in each of portions thereof, such as a background of the portion photographed with the finger 174 or the like.

Since finger coverage is easily generated in an outer circumference portion of image data and a main subject is not generally located in the outer circumference portion, the outer circumference portion is mostly a background. Since the background has less color change in each of portions thereof, disharmony is low even if a portion is substituted with another portion. Thus, the image composer 128 may generate composite data as if there is no finger coverage, wherein a part of the subject 190 may be left out in any one of the left eye image data and the right eye image data, with almost no disharmony in the background or the like.

When the difference determiner 152 determines that there is a difference, the edit controller 158 may enable the image processor 126 to cut out a part of each of the generated left eye image data and right eye image data, such that a portion having the difference, i.e., the portion where the finger 174 or the like is photographed, is excluded. In this case, the image processor 126 operates as an image cut-out unit, thereby cutting out a part of each of the generated left eye image data and right eye image data.

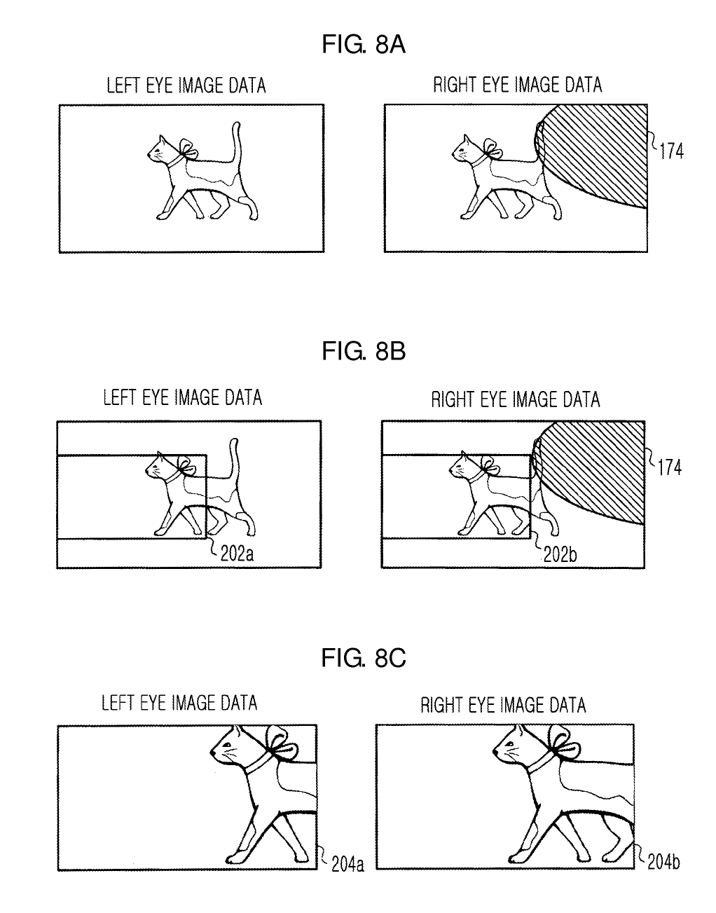

FIGS. 8A through 8C are views for explaining a cut-out process of the image processor 126. Specifically, FIG. 8A shows an example of the left eye image data and the right eye image data before the cut-out process is performed by the image processor 126, FIG. 8B shows an example of the left eye image data and the right eye image data after the cut-out process is performed by the image processor 126, and FIG. 8C shows an example of partial image data 204a and 204b that has been enlarged after the cut-out process is performed.

As shown in FIG. 8A, when the finger 174 is captured in the right eye image data, the edit controller 158 enables the image processor 126 to cut out partial image data 202b excluding a portion where the finger 174 is photographed shown in FIG. 8B after making an aspect ratio of the partial image data 202b the same as that of an original image. Then, the edit controller 158 enables the image processor 126 to cut out partial image data 202a of the left eye image data having the same size and located at the same location as the partial image data 202b in the right eye image data. Then, the edit controller 158 enables the image processor 126 to enlarge the cut-out partial image data 202a and 202b to the same size as the left eye image data or the right eye image data, for example, like an electronic zoom, to use them as the enlarged partial image data 204a and 204b, and substitute the left eye image data and the right eye image data respectively with the enlarged partial image data 204a and 204b.

As described above, when finger coverage is generated, the finger 174 or the like covers somewhere on the perimeter boundary of the imaging lens 104a or 104b. Accordingly, since the edit controller 158 enables the image processor 126 to cut out the partial image data 202b to avoid the portion where the finger 174 or the like is photographed, the portion with finger coverage can be completely excluded although a desired viewing angle is changed, and thereby the viewer is able to view an image that clearly forms a stereoscopic image. Also, when an area where finger coverage is generated is larger than a predetermined area, the edit controller 158 may control the image processor 126 to perform the above substituting process, and when the area is smaller than the predetermined area, the edit controller 158 may control the image processor 126 to perform the cut-out process. Accordingly, when an area where finger coverage is generated is relatively small, a stereoscopic image having low disharmony may be generated even if the cut-out process is performed, and thus a subject misaligned in a horizontal direction due to the substituting process may be avoided.

As described above, the control apparatus (central controller 138) and the stereoscopic image capturing apparatus 100 according to the present embodiment may quickly detect finger coverage with low load.

Control Method

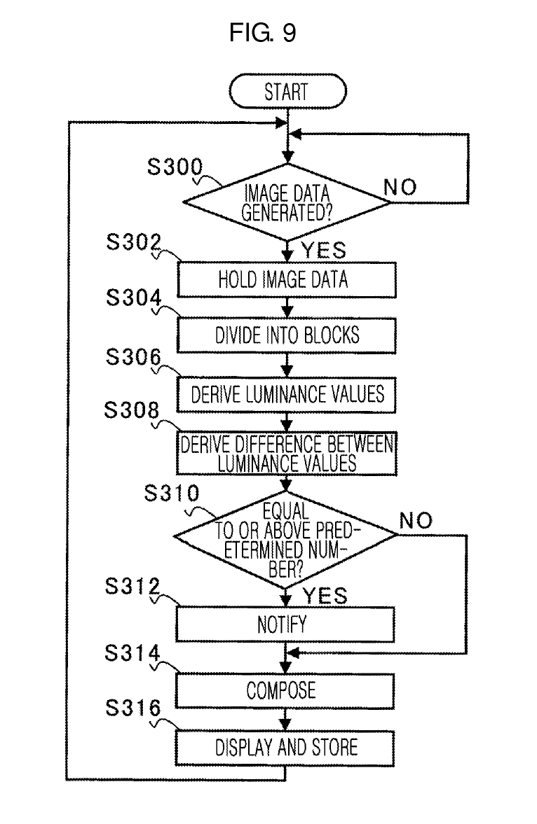

Also, a control method using the above-described control apparatus (central controller 138) is provided. FIG. 9 is a flowchart showing a flow of processes of the control method.

When the image pickup unit 120 generates image data (YES in step S300), the image buffer 122 temporarily holds the image data (step S302). The difference determiner 152 compares left eye image data and right eye image data held in the image buffer 122, based on a predetermined determination standard, here, quantity of light.

In detail, the difference determiner 152 divides the left eye image data and the right eye image data into predetermined blocks 176 and 178, respectively (step S304), and derives quantities of light in each of the blocks 176 and 178, i.e., luminance values in the present embodiment (step S306). Here, the difference determiner 152 derives the luminance values by dividing only a predetermined area excluding a center portion. Then, the difference determiner 152 derives a difference between the luminance values of the blocks 176 and corresponding blocks 178 (step S308). The difference determiner 152 determines whether a number of blocks in which the difference of luminance values exceeds a first predetermined value exceed a first predetermined number (step S310).

When the number of blocks in which the difference of luminance values exceeds the first predetermined value exceed the first predetermined number (YES in step S310), the difference determiner 152 determines that finger coverage is generated, and the notification controller 154 notifies the display unit 130, the speaker 134, and the LED 136 about the generation of the finger coverage (step S312).

When the number of blocks in which the difference of luminance values exceeds the first predetermined value does not exceed the first predetermined number (NO in step S310), the difference determiner 152 determines that finger coverage is not generated, and thus does not notify about generation of finger coverage.

Then, the image composer 128 composes the left eye image data and the right eye image data outputted from the image processor 126, thereby generating composite data by a predetermined method for making a viewer sense a stereoscopic image (step S314). The display unit 130 displays the composite data outputted by the image composer 128, and the image storage unit 132 stores the composite data outputted by the image composer 128 (step S316).

Here, the difference determiner 152 compares the left eye image data and the right eye image data by using quantity of light as a determination standard, but as described above, the left eye image data and the right eye image data may be compared by using resolution or similarity of shapes of subjects as a determination standard.

Also, when the difference determiner 152 determines that finger coverage is generated, the notification controller 154 notifies the display unit 130 and the speaker 134 about the finger coverage. However, as described above, the storage controller 156 may enable the image storage unit 132 not to perform storing, or the edit controller 158 may enable the image processor 126 to perform the substituting process or the cut-out process.

As described above, the control method according to the present embodiment can quickly detect finger coverage with low load.

The present invention may be used in a control apparatus and a control method for comparing an image for making a viewer sense a stereoscopic image, and a stereoscopic image capturing apparatus that generates an image for making a viewer sense a stereoscopic image.

According to the control apparatus, the stereoscopic image capturing apparatus, and the control method of the present invention, finger coverage can be quickly detected with low load.

While this invention has been particularly shown and described with reference to exemplary embodiments thereof, it will be understood by those skilled in the art that various changes in form and details may be made therein without departing from the spirit and scope of the invention as defined by the appended claims.

Also, each step of the control method described in the present specification does not have to be performed in time series according to the order shown in the flowchart, and may include a parallel process or a sub-routine process. Also, the present invention includes a program for executing functions of the central controller 138 in a computer. The program may be read from a recording medium and recorded on a computer, or transmitted via a communication network and recorded on a computer.

What is claimed is:

1. A control apparatus comprising:
a difference determiner which determines existence of a difference based on a predetermined determination standard by comparing left eye image data and right eye image data for making a viewer sense a stereoscopic image based on the predetermined determination standard; and
an execution controller which, when it is determined by the difference determiner that there is a difference, enables a controlled unit to execute a process different from when it is determined that there is no difference.

2. The control apparatus of claim 1, wherein the predetermined determination standard is quantity of light.

3. The control apparatus of claim 1, wherein the predetermined determination standard is resolution.

4. The control apparatus of claim 1, wherein the predetermined determination standard is a shape of a subject.

5. The control apparatus of claim 1, wherein the difference determiner compares the left eye image data and the right eye image data by using data corresponding to an area excluding at least a center portion of an image based on the left eye image data, and data corresponding to an area excluding at least a center portion of an image based on the right eye image data.

6. The control apparatus of claim 1, wherein the controlled unit is a notifying unit which notifies about information, and
when it is determined by the difference determiner that there is a difference, the execution controller enables the notifying unit to notify the result of the determination that there is the difference.

7. The control apparatus of claim 1, wherein the controlled unit is an image storage unit which stores the left eye image data and the right eye image data, and
the execution controller stores the left eye image data and the right eye image data in the image storage unit only when the difference determiner determines that there is no difference.

8. The control apparatus of claim 1, wherein the controlled unit is an image substitutor which substitutes partial image data of one of the left eye image data and the right eye image data with partial image data of the other of the left eye image data and the right eye image data, and
when the difference determiner determines that there is a difference, the execution controller enables the image substitutor to substitute the partial image data of one of the left eye image data and the right eye image data with the partial image data of the other of the left eye image data and the right eye image data, so as to reduce a difference in a portion having the difference.

9. The control apparatus of claim 1, wherein the controlled unit is an image cut-out unit which cuts out a part of each of the left eye image data and the right eye image data, and
when the difference determiner determines that there is a difference, the execution controller enables the image cut-out unit to cut out the part of each of the left eye image data and the right eye image data so as to exclude a portion having the difference.

10. A stereoscopic image capturing apparatus, the apparatus comprising:
the control apparatus of claim 1; and
an image pickup unit which generates the left eye image data and the right eye image data.

11. A control method comprising:
determining existence of a difference based on a predetermined determination standard by comparing left eye image data and right eye image data for making a viewer sense a stereoscopic image based on the predetermined determination standard; and
when there is the difference, executing a process that is different from a process executed when there is no difference.
